(19) United States
(12) Patent Application Publication
(10) Pub. No.: US 2015/0206439 A1
(43) Pub. Date: Jul. 23, 2015

(54) GROUND VEHICLE WARNING TO INDICATE PRESENCE OF AN OBSTACLE NEAR AN AIRCRAFT

(71) Applicant: Gulfstream Aerospace Corporation, Savannah, GA (US)

(72) Inventors: Michael L. Marsden, Savannah, GA (US); Frank Manochio, Savannah, GA (US); James T. Ward, Savannah, GA (US); Michael D. Knight, Savannah, GA (US); Jason A. Meade, Savannah, GA (US); Jeff Good, Savannah, GA (US)

(21) Appl. No.: 14/599,758

(22) Filed: Jan. 19, 2015

Related U.S. Application Data
(63) Continuation-in-part of application No. 14/159,064, filed on Jan. 20, 2014.

(51) Int. Cl. G08G 5/04; B64F 1/22; B64D 47/02

(52) U.S. Cl. CPC G08G 5/045; B64D 47/02; B64F 1/225

(57) ABSTRACT

The disclosed embodiments relate to avoiding a collision between an aircraft and an obstacle when the aircraft is being moved on a ground surface via a ground vehicle. Sensors can be mounted in and/or on the aircraft. The sensors can detect obstacles located in proximity to the aircraft and can communicate information to a processor onboard the aircraft. When the processor determines that an obstacle is located in proximity to the aircraft, the processor generates a warning generator signal, which causes an apparatus to communicate a warning signal that is perceptible to an operator of the ground vehicle to warn the operator of the obstacle.

### CROSS-REFERENCE TO RELATED APPLICATIONS

This application is a continuation-in-part of U.S. Non-Provisional patent application Ser. No. 14/159,064, filed Jan. 20, 2014, and entitled “Providing a Warning Signal to a Ground Vehicle Operator to Indicate Presence of an Obstacle near an Aircraft” and is hereby incorporated by reference in its entirety.

### TECHNICAL FIELD

Embodiments of the present invention generally relate to aircraft, and more particularly relate to methods and systems that use sensors mounted in and/or on an aircraft to detect the presence of an obstacle on a ground surface in proximity to the aircraft.

### BACKGROUND OF THE INVENTION

It is common to use a ground vehicle to move an aircraft when the aircraft is on the ground. For example, an operator of the ground vehicle must often drive and maneuver the aircraft using the ground vehicle during ground operations, such as when an aircraft is being maneuvered to or from a hangar, or being backed away from a terminal The ground vehicle used to move the aircraft is commonly referred to as a tug, tractor or towing equipment.

In some cases, obstacles on the ground may lie in the path of a vehicle. Examples of such obstacles include structures and other vehicles including other aircraft that are either stationary or moving. In some cases, these obstacles can be detected by the operator using natural vision. However, in many cases, due to the dimensions of the aircraft (e.g., large wing sweep angles, distance from cockpit to wingtip, etc.) and the operator's field of view of the areas surrounding the aircraft is limited, making it difficult for the operator to monitor extremities of the aircraft during towing operations (e.g., the ground vehicle operator may not be able to directly view extremities of the aircraft during towing operations). As a result, the operator of the ground vehicle may fail to detect obstacles that are located in certain “blind spots” that are in close proximity of the aircraft. In many cases, the operator may only detect an obstacle when it is too late to take the action needed to prevent a collision with the obstacle.

Collisions with an obstacle can not only damage the aircraft, but can also put the aircraft out of service and result in flight cancellations. The costs associated with the repair and grounding of an aircraft can be significant. Collisions with an obstacle can also lead to damage to fixed structures or other vehicles, such as parked aircraft, that are located within the tow path of the aircraft. As such, the timely detection and avoidance of obstacles is an important issue that needs to be addressed.

Accordingly, when the aircraft is being moved by the ground vehicle, it is desirable to provide methods, systems and apparatus that can provide warning signals, alerts, or other indications that are perceptible to the operator of the ground vehicle to help reduce the likelihood of and/or prevent collisions with the detected obstacles. It would also be desirable to assist the operator of the ground vehicle with maneuvering the aircraft and to provide the operator with aided guidance while moving the aircraft so that collisions with such obstacles can be avoided. It would also be desirable to provide an aircraft that includes sensors that can be used to detect obstacles on the ground and identify aircraft position with respect to the detected obstacles (e.g., in proximity of the wings, tail or other portions of the aircraft that the ground vehicle operator can not directly observe). It would also be desirable to provide the operator of the ground vehicle with an opportunity to take appropriate action to prevent a collision from occurring between the aircraft and the detected obstacles when the aircraft is being moved. Furthermore, other desirable features and characteristics of the present invention will become apparent from the subsequent detailed description and the appended claims, taken in conjunction with the accompanying drawings and the foregoing technical field and background.

### SUMMARY

The disclosed embodiments relate to systems and apparatus for avoiding a collision between an aircraft and an obstacle when the aircraft is being moved on a ground surface via a ground vehicle. When a sensor detects an obstacle in proximity to the aircraft, a warning signal is generated that is perceptible to an operator of the ground vehicle to warn the operator of the obstacle. In one embodiment, the sensor can be mounted in an aircraft structure (e.g., mounted completely within the interior of the aircraft). In another embodiment, the sensor can be mounted in an opening formed in the aircraft structure such that the sensor is mounted both inside the interior of the aircraft and outside of the aircraft structure. In another embodiment, a detachable sensor apparatus is provided that is detachably mounted on an outside of the aircraft structure of the aircraft. The detachable sensor apparatus includes an attachment mechanism configured to temporarily mount the detachable sensor apparatus to the exterior of the aircraft.

In another embodiment, a collision avoidance system is provided that includes an aircraft, a ground vehicle that is mechanically coupled to the aircraft to move the aircraft along a ground surface, and an apparatus. The aircraft comprises proximity sensors mounted at extremity portions of the aircraft, and an onboard computer that is communicatively coupled to the proximity sensors. Each of the proximity sensors is configured to detect presence of obstacles in proximity to the aircraft, and to transmit a detection signal when an obstacle is detected. When a particular one of the proximity sensors detects that an obstacle is present, that particular proximity sensor generates a detection signal to indicate that an obstacle has been detected. The onboard computer comprises a processor that is configured to determine, in response to receiving the detection signal, that an obstacle is located in proximity to the aircraft, and to generate a warning generator signal in response to determining that the obstacle is located in proximity to the aircraft. In response to the warning generator signal, the apparatus can communicate a warning signal that is perceptible to an operator of the ground vehicle to warn the operator of the obstacle.

### DESCRIPTION OF THE DRAWINGS

Embodiments of the present invention will hereinafter be described in conjunction with the following drawing figures, wherein like numerals denote like elements, and

FIG. 1 is a top view of an aircraft that includes instrumentation for implementing a collision warning and avoidance system in accordance with some of the disclosed embodiments;

FIG. 2 is an illustration of a side view of an aircraft under being towed via a ground vehicle in accordance with an embodiment;

FIG. 3A is an illustration of a side view of the ground vehicle in accordance with an embodiment;

FIG. 3B is an illustration of a front view of the ground vehicle in accordance with an embodiment;

FIG. 3C is an illustration of a top view of the ground vehicle in accordance with an embodiment;

FIG. 4 is a block diagram of a collision warning and avoidance system that can be implemented in an aircraft in accordance with an exemplary implementation of the disclosed embodiments;

FIG. 5 is a flowchart of a method for providing a warning to an operator of the ground vehicle when an obstacle is detected in proximity to the aircraft in accordance with some of the disclosed embodiments;

FIG. 6 is an illustration of a cross sectional view of a portion of an aircraft in accordance with an embodiment;

FIG. 7 is an illustration of a cross sectional view of a portion of an aircraft in accordance with another alternative embodiment;

FIG. 8 is an illustration of a perspective view of a wing of an aircraft and a detachable sensor apparatus in accordance with an embodiment; and

FIG. 9 is an illustration of a perspective view of a wing of an aircraft and a detachable sensor apparatus in accordance with another embodiment.

### DESCRIPTION OF EXEMPLARY EMBODIMENTS

As used herein, the word “exemplary” means “serving as an example, instance, or illustration.” The following detailed description is merely exemplary in nature and is not intended to limit the invention or the application and uses of the invention. Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary or the following detailed description.

As will be described in greater detail below, the disclosed embodiments provide systems for signaling an operator of a ground vehicle that potential obstacles are present near an aircraft. When an obstacle is detected, one or more warning signals can be generated to signal the operator that an obstacle is in proximity of the aircraft, and provide a warning to the operator that there is a risk of a collision with the detected obstacle. This way the operator can react and take appropriate action to avoid colliding with the detected obstacle. The warning signal can vary depending on the implementation, and can generally be, for example, any known type of warning signal that is designed to attract a person's attention either audibly (e.g., an alarm or other audible warning), visually (e.g., a flashing light or image presented on a display) and/or hapticly or tactilely (e.g., vibrating the steering wheel or other part of the ground vehicle).

A plurality of proximity sensors can be mounted in or on an aircraft structure that is a portion of the aircraft.

In one embodiment, the aircraft structure comprises an internal surface, an external surface, and a window that serves as a cover for a first proximity sensor of the plurality of proximity sensors. The first proximity sensor can be mounted in the aircraft structure between the internal surface and the external surface and flush with such that it is flush with the external surface. A mounting structure can be attached to the internal surface such that the first proximity sensor can be mounted completely within the interior of the aircraft.

In another embodiment, a fairing structure can be attached to the external surface. The first proximity sensor of the plurality of proximity sensors is mounted in an opening formed in the aircraft structure between the internal surface and the external surface such that a first portion of the first proximity sensor is mounted inside the interior of the aircraft structure, a second portion of the first proximity sensor is mounted in the opening, and a third portion of the first proximity sensor is mounted in the fairing structure and protrudes outside of the aircraft structure.

In another embodiment, a detachable sensor apparatus is provided that is detachably mounted on an outside of the aircraft structure of the aircraft. The detachable sensor apparatus includes an attachment mechanism configured to temporarily mount the detachable sensor apparatus to the exterior of the aircraft. The detachable sensor apparatus also includes a first proximity sensor, a housing, a processor, a power source that provides electrical power to the first proximity sensor and the processor, an antenna and a wireless communication interface that includes a wireless receiver and a wireless transmitter. The first proximity sensor, the power source, the processor and the wireless communication interface are mounted inside the housing. The wireless transmitter is configured to communicate information acquired by the first proximity sensor over a wireless communication link to another device. The attachment mechanism can be implemented in a number of different ways. In one embodiment, the attachment mechanism comprises straps that are attached to the housing and that secure the detachable sensor apparatus to the exterior surface of the aircraft. In another embodiment, the attachment mechanism comprises fasteners that are attached to the housing and that secure the detachable sensor apparatus to the exterior surface of the aircraft. For instance, in one implementation, the fasteners comprise: retaining pins that are inserted in holes formed along a surface of the aircraft. In another embodiment, the attachment mechanism comprises a slip cover that is attached to the housing and slides over the exterior surface of the aircraft. In still another embodiment, the attachment mechanism comprises a quick release mechanism that is attached to the housing and secures the housing to the exterior surface of the aircraft

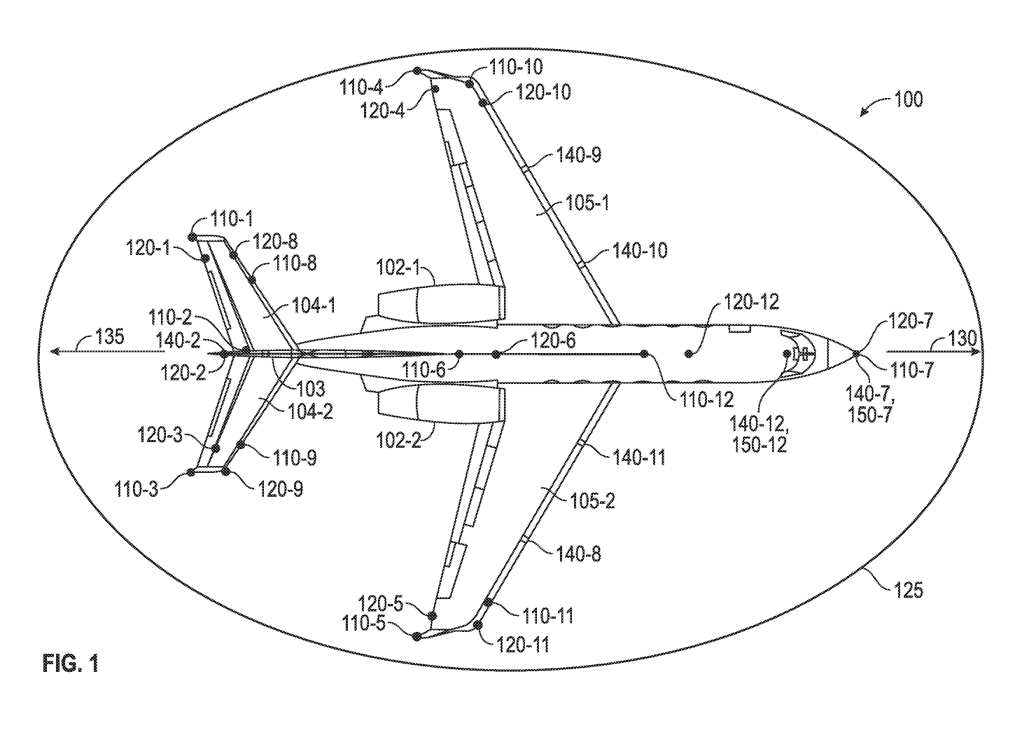

FIG. 1 is a top view of an aircraft 100 that includes instrumentation for implementing a collision warning and avoidance system in accordance with some of the disclosed embodiments. In FIG. 1, the forward direction is designated via reference number 130, whereas the rearward direction is designated via reference number 135. As will be described below, the collision warning and avoidance system can be used to reduce or eliminate the likelihood of collision of an aircraft 100 with ground obstacles that are in proximity of the aircraft when the aircraft is being moved on a ground surface by a ground vehicle.

In accordance with one non-limiting implementation of the disclosed embodiments, the aircraft 100 includes a vertical stabilizer 103, two horizontal stabilizers 104-1 and 104-2, two main wings 105-1 and 105-2, two jet engines 102-1, 102-2, proximity sensors 110-1 . . . 110-12 that are disposed at points of extremity of the aircraft 100 (e.g., those portions of the aircraft 100 most likely to collide with an obstacle) of the aircraft 100, video imagers 120-1 . . . 120-12, external visual warning equipment 140, external audio warning equipment 150. Although the jet engines 102-1, 102-2 are illustrated as being mounted to the fuselage 102, this arrangement is non-limiting and in other implementations the jet engines 102-1, 102-2 can be mounted on the wings 105-1, 105-2. The number and respective locations of the proximity sensors 110, the video imagers 120, the external visual warning equipment 140, and the external audio warning equipment 150 are also non-limiting. Depending on the implementation any number of each can be used at any location on the aircraft 100. In other implementations, either fewer or more of the proximity sensors 110, the video imagers 120, the external visual warning equipment 140, and the external audio warning equipment 150 can be implemented, at either the same or different locations on the aircraft 100.

### Proximity Sensors

The proximity sensors 110-1 . . . 110-12 are disposed at extremity locations on the aircraft 100 that can not easily be monitored by the operator. It is noted that the terms “extremity locations,” “points of extremity,” and “extremity portions” are used interchangeably herein. In one embodiment, the proximity sensors 110-1 . . . 110-12 are oriented so respective coverage areas of the proximity sensors 110 are arranged to provide a full 360-degree detection coverage (e.g., within ellipse 125) for the aircraft 100 so that any obstacles in the space surrounding the aircraft 100 or in the vicinity of the aircraft 100 can be detected.

In the exemplary embodiment illustrated in FIG. 1, proximity sensors 110-1 and 110-3 may be disposed along (e.g., embedded at) opposite rearward-facing sides of the aircraft horizontal stabilizer (or tail) 104-1, 104-2, proximity sensor 110-2 may be disposed along the aircraft vertical stabilizer 103 (or along the opposite sides of an upper aircraft horizontal stabilizer in some implementations that have a T-tail stabilizer configuration), proximity sensors 110-4, 110-5 may be disposed along opposite rearward-facing sides of the wing tips, proximity sensor 110-6 may be disposed on the underside of the aircraft fuselage 102 along the bottom-most portion of the aircraft fuselage 102, and the proximity sensor 110-7 may be disposed along the nose of the aircraft, proximity sensors 110-8, 110-9 may be disposed along the opposite forward-facing sides of the aircraft horizontal stabilizer, and proximity sensors 110-10, 110-11 may be disposed along opposite forward-facing sides of the wings, and proximity sensor 110-12 may be disposed along the top-most portion of the aircraft fuselage 102.

Each of the proximity sensors 110-1 . . . 110-12 are used to detect obstacles that may be present within their detection zone (e.g., within a particular region that is in the vicinity of the aircraft 100). Each of the proximity sensors 110-1 . . . 110-12 emit pulses (e.g., electromagnetic wave pulses, sound wave pulses, pulses of visible, ultraviolet or infrared light, etc.) which are directed and emitted as a broad beam towards a particular detection zone covering the field of view of the proximity sensor. The duration of the pulses define a detection zone of each proximity sensor. For a short period of time after each pulse is emitted by that proximity sensor, waves may be reflected back towards the sensor by an obstacle. The period of time is approximately equal to the time required for a pulse to travel from the proximity sensor 110 to the detection zone and for a portion of the wave that is reflected towards the sensor 110 from an obstacle to reach the sensor 110. The period of time enables the distance between the sensor 110 and an obstacle within the detection zone to be calculated. For example, it is possible to measure the time required for a pulse to be reflected and use the time to calculate a distance between the sensor and a reflecting surface of the obstacle. For instance, the distance between the sensor 110 and the detection zone can be calculated as the speed of the sensor medium (e.g., speed of light) divided by the time delay between transmitting the pulse and receiving a reflected wave from an obstacle within its detection zone. In some embodiments, such as when the proximity sensors are ultrasonic sensors, the calculation may also need to take into account the distance the aircraft travels during the time between transmitting the pulse and receiving the reflected wave from the obstacle. For instance, if an object were located 200 feet away from the aircraft and the taxi speed of the aircraft were 20 miles per hour, the aircraft would travel approximately 10 to 12 feet between transmission of the pulse signal and receiving the reflected wave.

The types of proximity sensors 110-1 . . . 110-12 that are employed may vary depending on the implementation. In one implementation, the proximity sensors 110-1 . . . 110-12 may be implemented using sonar or ultrasonic sensors (or transceivers) that generate and transmit sound waves. These proximity sensors receive and evaluate the echo that is reflected back to the proximity sensor. The time interval between sending the signal and receiving the echo can be used to determine the distance between the proximity sensor and a detected obstacle.

However, in other implementations, the proximity sensors 110-1 . . . 110-12 may be implemented using radar sensors, laser sensors, infrared sensors, light detection and ranging (LIDAR) sensors, infrared or laser rangefinders that use a set of infrared or laser sensors and triangulation techniques to detect an obstacle and to determine its distance from the aircraft, etc. For example, in one embodiment, the proximity sensors 110-1 . . . 110-12 can be infrared sensors that include an infrared light transmitter and receiver. Short light pulses are transmitted by the transmitter, and when at least some light pulses are reflected by an obstacle, the obstacle is detected by the receiver.

The range of distances that are within the field of view (FOV) of the proximity sensors 110-1 . . . 110-12 define obstacle detection zones for each proximity sensor 110. The range of distances that are within the field of view of the proximity sensors 110-1 . . . 110-12 can vary depending on the implementation and design of the aircraft 100. Because the speed of ground operations is typically slow when the aircraft 100 is being moved, FOV and the range of the proximity sensors 110-1 . . . 110-12 should be limited to prevent nuisance activations of the system, but still allow enough time to take action when an obstacle is detected in the path of the aircraft 100. In one implementation, the field of view of the proximity sensors 110-1 . . . 110-12 can be between about 10 to 20 degrees, and the range can be up to about 200 feet. At a towing speed of approximately 3 to 5 miles per hour that would give the operator of a ground vehicle that is moving the aircraft 100 approximately 5 seconds to react to a warning from the proximity sensor.

In some embodiments, field of view and range of the proximity sensors 110-1 . . . 110-12 can be varied. For example, the size and location of the detection zone relative to the sensor 110 (and therefore the aircraft 100) can be varied in response to changes in the aircraft 100 speed or movements of the aircraft 100 to provide adequate warnings of a likely collision and to ensure that the operator of a ground vehicle that is moving the aircraft 100 will have sufficient time to take evasive action and prevent a collision from occurring should a warning signal be generated.

In some embodiments, the size of the detection zone or field of view of the sensor can be varied by changing the duration of a period or time (or duty cycle) during which the proximity sensor 110 is activated. When the period of time between emitted pulses is varied, the range of the proximity sensor 110 is varied. By reducing the period of time the detection zone is brought closer to the sensor 110, while increasing the time delay has the effect of moving the detection zone further away from the sensor 110. Thus, the detection zone may be moved away from the aircraft 100 in response to acceleration of the aircraft 100, and moved towards the aircraft 100 in response to deceleration of the aircraft 100.

### Video Imagers

The video imagers 120-1 . . . 120-12 are disposed at the locations on the aircraft 100 that cannot be visually monitored by the operator and oriented so that their respective fields of view of the video imagers 120 are arranged to provide a full 360-degree effective field of view 125 of the aircraft 100 so that video images of any obstacles in the vicinity of the aircraft 100 can be acquired and monitored by aircraft personnel. In the exemplary embodiment illustrated in FIG. 1, video imagers 120-1 and 120-3 may be disposed along opposite rearward-facing sides lower aircraft horizontal stabilizers 104-1 and 104-2, video imager 120-2 may be disposed along the aircraft vertical stabilizer 103, video imagers 120-4, 120-5 may be disposed along opposite rearward-facing sides of the wing tips, video imager 120-6 may be disposed along the bottom-most portion of the aircraft fuselage 102 to allow viewing of at least part of the region below the aircraft, the video imager 120-7 may be disposed along the nose of the aircraft, video imagers 120-8, 120-9 may be disposed along the opposite forward-facing sides of the aircraft horizontal stabilizer, video imagers 120-10, 120-11 may be disposed along opposite forward-facing sides of the wings, and video imager 120-12 may be disposed along the top-most portion of the aircraft fuselage 102 to allow viewing of at least part of the region above the aircraft. It is noted that in other implementations, the aircraft may employ a T-tail stabilizer configuration that includes a vertical stabilizer and an upper horizontal stabilizer at the top of the vertical stabilizer. With such T-tail stabilizer configurations, additional video imagers (and proximity sensors) can be located along the opposite sides of the upper horizontal stabilizer.

Each of the video imagers 120-1 . . . 120-12 can be used to acquire video images of a particular region around the aircraft (including any obstacles that may be present in the vicinity of the aircraft 100), and to generate video signals (referred to herein as video image signals). Each of the video imagers 120-1 . . . 120-12 is capable of acquiring video images of a particular region (within its field of view) that is in the vicinity of the aircraft 100. For example, the video imager 110-2 that is disposed along the aircraft vertical stabilizer, and the video imagers 110-4, 110-5 that are disposed along opposite sides of the wing tips can be used to view video images of regions around the aircraft that are often damaged when the aircraft 100 moves in a reverse direction 135. In some operating scenarios, a particular region may include one or more obstacles within that particular region.

Each of the video imagers 120-1 . . . 120-12 are operable to acquire (either prior to or during the commencement of motion of the aircraft 100) an image of a corresponding detection zone into which the aircraft 100 will move. The image can include detected obstacles, when present, and therefore, the video imagers 120-1 . . . 120-12 are operable to acquire an image of obstacles that might be located within a predetermined range of distances and within a field of view associated with the video imagers 120-1 . . . 120-12.

The video imagers 120-1 . . . 120-12 that are employed may vary depending on the implementation. In general, each video imager can be implemented using a video camera or other image capture apparatus. In some implementations, the video imagers 120-1 . . . 120-12 may be implemented using cameras such as high-definition video cameras, video cameras with low-light capability for night operations and/or cameras with infrared (IR) capability, or any combinations thereof, etc.

The field of view of the video imagers 120-1 . . . 120-12 can vary depending on the implementation and design of the aircraft 100 so that the detection zone can be varied either by the operator or automatically depending on other information. In some embodiments, the field of view of the video imagers 120-1 . . . 120-12 can be fixed, while in others it can be adjustable. For example, in one implementation, the video imagers 120 can be cameras with a variable focal length (zoom lens) which can be varied to vary the FOV and/or direction of view. This feature can be used to vary the range and field of view based on the surrounding area and/or the speed and direction of travel of the aircraft so that the location and size of the space being imaged can be varied. When the video imagers 120-1 . . . 120-12 have an adjustable FOV (e.g., a variable FOV), a processor (not illustrated in FIG. 1) can command the camera lens to a preset FOV. In general, the field of view of the video imagers 120-1 . . . 120-12 is typically much wider than in comparison to that that of the proximity sensors 110. For example, in one implementation, the field of view of the video imagers 120-1 . . . 120-12 can be between about 150 to 160 degrees. The range of the video imagers 120-1 . . . 120-12 can also vary depending on the implementation and design of the aircraft 100.

In some implementations, the information acquired by the proximity sensors 110-1 . . . 110-12 can be processed to construct an image of any obstacles that lie within their field of view, in which case the video imagers 120-1 . . . 120-12 can be eliminated altogether.

The external visual warning equipment 140 can include things such as external lights that are mounted on the aircraft 100. The external audio warning equipment 150 can include audio elements such as speakers, horns, bells, etc. that are mounted on the aircraft 100. As will be described in greater detail below, when any of the proximity sensors 110-1 . . . 110-12 detect an obstacle (not illustrated), apparatus, including the external visual warning equipment 140 and/or external audio warning equipment 150 of the aircraft 100, can generate and communicate warning signals that are perceptible to an operator of the ground vehicle to warn the operator of the obstacle.

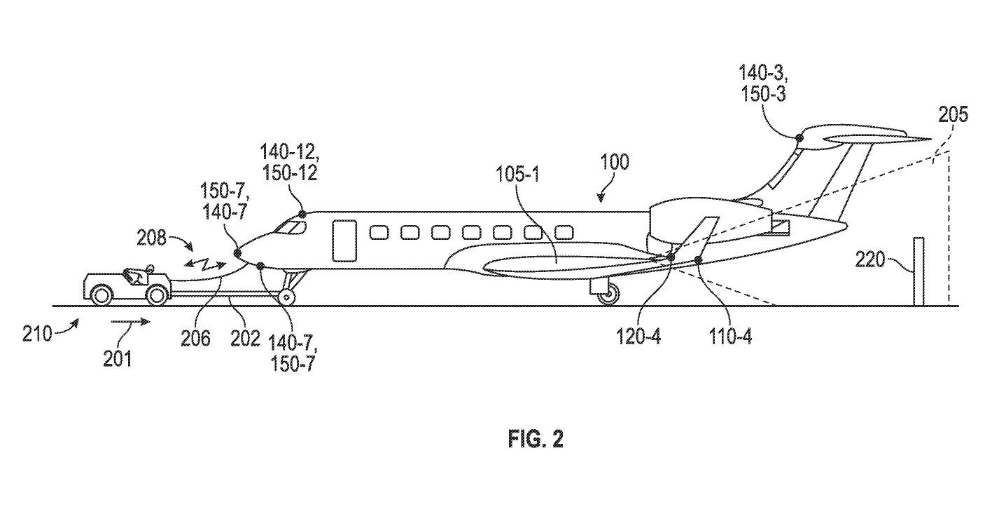

FIG. 2 is an illustration of a side view of an aircraft 100 being towed via the ground vehicle 210 in accordance with an embodiment. The aircraft includes various proximity sensors 110, video imagers 120, external visual warning equipment 140 (referred to below as external lights, but not limited thereto) and external audio warning equipment 150 (referred to below as speakers, but not limited thereto) that are described above with reference to FIG. 1. To illustrate one non-limiting example, the aircraft 100 of FIG. 2 is illustrated to show only one of the proximity sensors 110-4, only one of the imagers 120-4, only three of the lights 140-3, 140-7, 140-12, and only three of the speakers 150-3, 150-7, 150-12 although any number of each can be included depending on the implementation. For sake of brevity those sensors, imagers, lights, and speakers will not be described again.

The ground vehicle 210 is mechanically coupled to the aircraft 100 via a link 202 so that the ground vehicle 210 can move the aircraft 100.

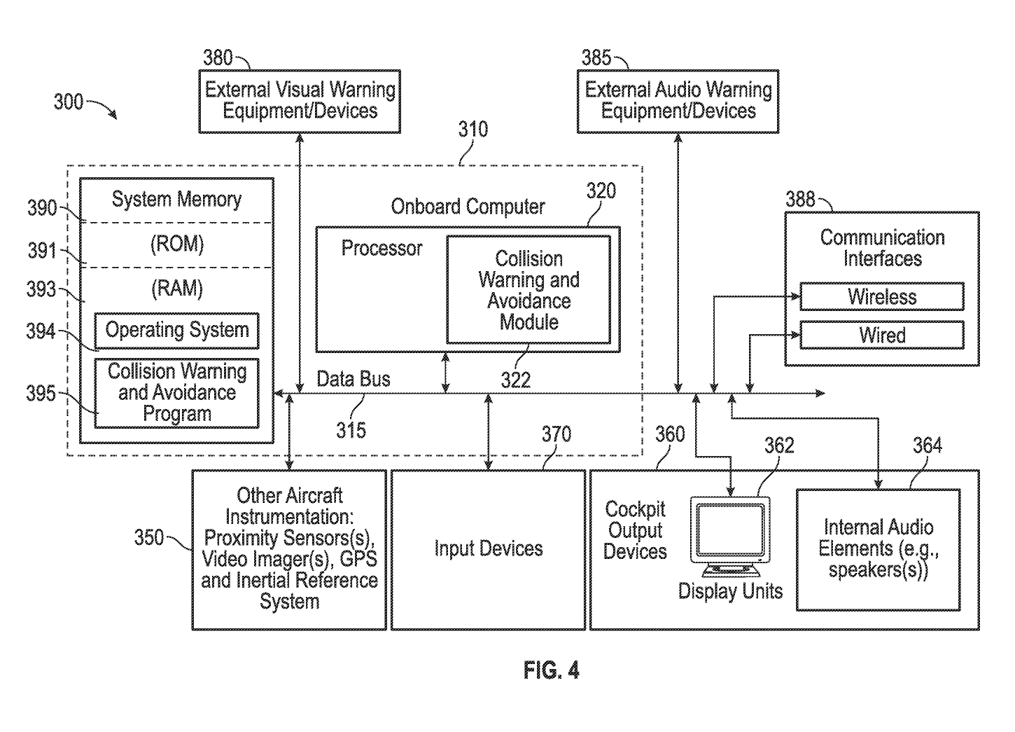

The ground vehicle 210 is communicatively coupled to the aircraft via communication links 206, 208. Although not illustrated in FIG. 2, the ground vehicle 210 includes wired and wireless communication interfaces that are mounted in or on the ground vehicle 210, or that are provided as part of communication devices that are mounted in or on the ground vehicle 210. The aircraft 100 also includes wired and wireless communication interfaces (not illustrated in FIG. 2, but shown in FIG. 4) that are mounted in the aircraft. A wired communication link 206 communicatively couples at least one of the wired communication interfaces that are implemented at the aircraft 100 and a corresponding wired communication interface implemented at the ground vehicle 210. At least one wireless communication link 208 communicatively couples the wireless communication interfaces that are implemented at the aircraft 100 and the ground vehicle 210.

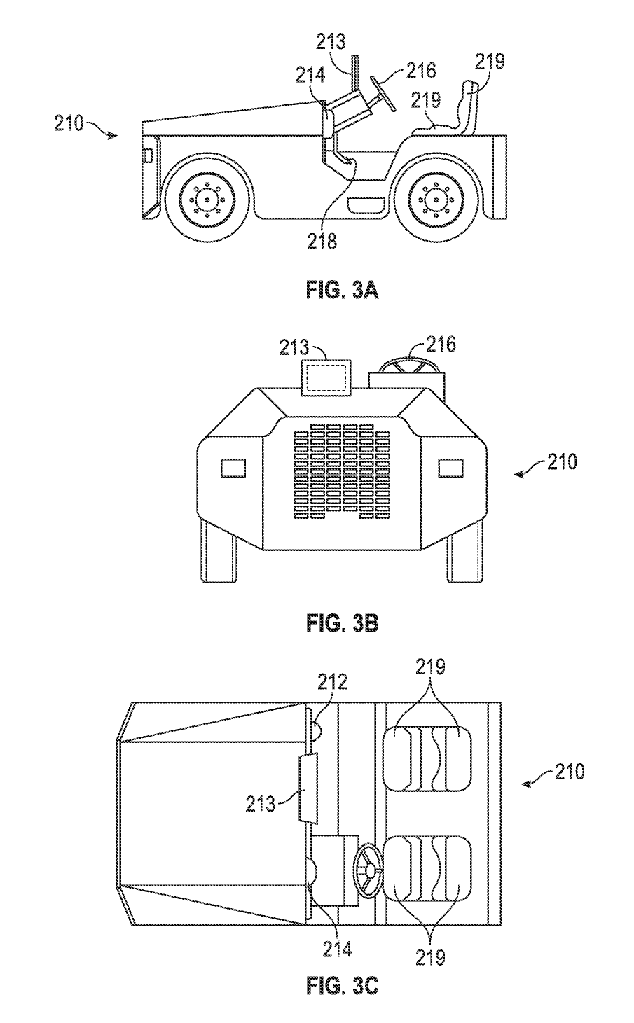

FIGS. 3A through 3C show various views of the ground vehicle 210. More specifically, FIG. 3A is an illustration of a side view of the ground vehicle 210 in accordance with an embodiment, FIG. 3B is an illustration of a front view of the ground vehicle 210 in accordance with an embodiment, and FIG. 3C is an illustration of a top view of the ground vehicle 210 in accordance with an embodiment. In accordance with some of the disclosed embodiments, the ground vehicle 210 can be equipped with various alert apparatus including visual alert equipment/devices (such as display 213 of FIGS. 3A-3C), audio alert equipment/devices (such as speaker 214 of FIGS. 3A-3C), and haptic alert equipment/devices (such as haptic systems or devices located in the steering wheel 216, accelerator and brake pedals 218, seats 219 of FIGS. 3A-3C). Although not shown, the ground vehicle 210 can also include an automatic braking system that can be activated when the obstacle 220 is detected.

Referring again to FIG. 2, the proximity sensor 110-4 has a rearward field of view 205 from the tip of the main wing 105- 1, and can detect obstacles within this rearward field of view 205. When the proximity sensor 110-4 detects the obstacle 220, a processor onboard the aircraft 100 receives a detection signal from the proximity sensor 110-4. Based on the detection signal, the processor determines that an obstacle 220 is located in proximity to the aircraft 100, and generates one or more warning generator signals. In some embodiments, before the processor generates the one or more warning generator signal(s), the processor can also determine whether the aircraft is likely to collide with the obstacle 220 or is on a collision course with the obstacle 220. The processor communicates the warning generator signal(s) to the communication interfaces at the aircraft 100. The communication interfaces then transmit the warning generator signal(s), using the wired communication link 206 and/or one of the wireless communication link 208, to one or more of the alert equipment/devices (such as a warning light 212, a display 213, a speaker 214 or tactile feedback devices 216, 218, 219) that are located in or on the ground vehicle 210, and/or to apparatus (not illustrated) associated with the operator of the ground vehicle 210, such as glasses worn by the operator having a display or light system integrated therein, and/or headphones worn by the operator that have a speaker system (or other audio element) integrated therein.

In response to receiving the warning generator signal(s), at least one of the alert equipment/devices and/or to apparatus associated with the operator can generate and communicate a warning signal that is perceptible to an operator of the ground vehicle 210 to warn the operator of the obstacle 220. Here, “perceptible to the operator” refers to the fact that the warning signal can be communicated to the operator via touch, sight, or sound (e.g., via any haptic, visual, or audible signal to warn the operator of the ground vehicle 210 of the obstacle 220, or via any haptic/tactile, visual, or auditory modality). The warning signal indicates to the operator of the ground vehicle 210 that an obstacle has been detected in the path of the aircraft, and that there is potential for a collision between the aircraft 100 and the obstacle 220. Warning generator signals, the apparatus they can be communicated to, and the different types of warning signals will be described in greater detail below.

In addition, in some embodiments, the warning generator signals can include additional information such as video images that can then be presented to the operator on a display (such as display 213) associated with the ground vehicle 210.

For example, in one non-limiting implementation that is illustrated in FIG. 2, video images within the rearward field of view 205 (that are acquired by the video imager 120-4) can be presented to the operator of the ground vehicle 210 on a display to provide the rearward view from the tip of the main wing 105- 1 to the operator of the ground vehicle 210. In some implementations, additional information can be displayed to the operator such as the predicted path of the wing tip. Optionally, images of the wingtips could be transmitted to a computer or other device carried or worn by the operator of the ground vehicle 210.

FIG. 4 is a block diagram of a collision warning and avoidance system 300 that can be implemented in an aircraft 100 in accordance with an exemplary implementation of the disclosed embodiments. The avoidance system 300 includes an onboard computer 310, aircraft instrumentation 350, cockpit output devices 360 (e.g., display units 362 such as control display units, multifunction displays (MFDs), etc., internal audio elements 364, such as speakers located in the cockpit, etc.), various input devices 370 such as a keypad which includes a cursor control device, and one or more touchscreen input devices which can be implemented as part of the display units, visual warning equipment/devices 380 that are located in or on the exterior of the aircraft 100, audio warning equipment/devices 385 that are located in or on the exterior of the aircraft 100, and communication interfaces 388 that can be used to communicate signals to the ground vehicle 210 and other external communication interfaces. The various systems of the 300 will be described below with reference to FIG. 4.

The onboard computer 310 includes a data bus 315, a processor 320, and system memory 390. The data bus 315 is used to carry signals communicated between the processor 320, and the other blocks of FIG. 4.

The aircraft instrumentation 350 can include, for example, the proximity sensors, video imagers, elements of a Global Position System (GPS), which provides GPS information regarding the position and speed of the aircraft, and elements of an Inertial Reference System (IRS). In general, the IRS is a self-contained navigation system that includes inertial detectors, such as accelerometers, and rotation sensors (e.g., gyroscopes) to automatically and continuously calculate the aircraft's position, orientation, heading and velocity (direction and speed of movement) without the need for external references once it has been initialized.

The cockpit output devices 360 can include display units 362 and internal audio elements 364. The display units 362 can be implemented using any man-machine interface, including but not limited to a screen, a display or other user interface (UI). The audio elements can include speakers and circuitry for driving the speakers.

The input devices 370 can generally include, for example, any switch, selection button, keypad, keyboard, pointing devices (such as a cursor control device or mouse) and/or touch-based input devices including touch screen display(s) which include selection buttons that can be selected using a finger, pen, stylus, etc.

The system memory 390 can includes non-volatile memory (such as ROM 391, flash memory, etc.), volatile memory (such as RAM 392), or some combination of the two. The RAM 392 includes an operating system 394, and a collision warning and avoidance program 395. The processor 320 uses or executes the collision warning and avoidance program 395 (stored in system memory 390) to implement a collision warning and avoidance module 322 at processor 320. The collision warning and avoidance program 395 can include, among other things, a proximity sensor program module, a video imager and image display program module, and a ground vehicle warning module.

The proximity sensor program module can be programmed to control the field of view of the proximity sensors, and to control the type and frequency of alert signals generated in response to detection signals from the proximity sensors. As will be described below, the signals can be provided to visual warning equipment/devices 380, audio warning equipment/devices 385, and communication interfaces 388 (for communication to other apparatus), for example, whenever a potential obstacle is detected by the proximity sensors as approaching, or being approached by, the aircraft 100.

The video imager and image display program module is programmed to control characteristics (e.g., the field of view) of the video imagers and video image signals generated by the video imagers. The video imager and image display program module also controls the transmission of selected ones of the video image signals. In some implementations, the video imager and image display program module may be configured to process images (e.g., raw camera data) received from the video imagers so as to determine the range of an obstacle from the video imagers, movement of an obstacle, etc. This data can be used by the processor 320 to perform one or more tasks as described below.

The ground vehicle warning module is configured to receive detection signals communicated from any of the proximity sensors 110. Upon receiving a detection signal from a particular proximity sensor that has detected the obstacle 220, the processor 320 determines that an obstacle 220 is located in proximity to the aircraft 100, and generates a warning generator signal that it communicates to one or more apparatus. As will be described in greater detail below, the apparatus can be located in or on the aircraft 100 (e.g., visual warning equipment/devices 380 or audio warning equipment/devices 385), located in or on the ground vehicle 210, located external to the ground vehicle 210 and the aircraft 100, and/or can be an operator apparatus associated with the operator of the ground vehicle 210, etc.

In the particular example illustrated in FIGS. 1, 2 and 4, warning equipment located in or on the aircraft 100 can include visual warning equipment/devices 380 and audio warning equipment/devices 385 that are located in or on the exterior of the aircraft 100. The visual warning equipment/devices 380 that are located in or on the exterior of the aircraft 100 can include, for example, any of the external visual warning equipment 140 that are described with reference to FIGS. 1 and 2. The audio warning equipment/devices 385 that are located in or on the exterior of the aircraft 100 can include external audio elements of the aircraft 100 such as, for example, any of the external audio warning equipment 150 that are described with reference to FIGS. 1 and 2.

In response to receiving the warning generator signal, at least one apparatus communicates a warning signal that is perceptible to an operator of the ground vehicle 210 to warn the operator of the obstacle 220. The warning signal can be any combination of visual, audio and/or haptic indication(s). The warning signal indicates to the operator of the ground vehicle 210 that an obstacle has been detected in the path of the aircraft, and that there is potential for a collision between the aircraft 100 and the obstacle 220. Warning generator signals, the apparatus they can be communicated to, and the different types of warning signals will be described in greater detail below.

The communication interfaces 388 can include wired communication interfaces and wireless communication interfaces. The wired communication interfaces can be coupled to corresponding wired communication interfaces of the ground vehicle 210 (e.g., shown in FIGS. 2 and 3A-3C, but not illustrated in FIG. 4) via the wired communication link 206 of FIG. 2. The wireless communication interfaces are operatively and communicatively coupled antennas (not illustrated) that can be external to the on-board computer 310. The wireless communication interfaces can be coupled to corresponding wireless communication interfaces associated with the ground vehicle 210 via one or more of the wireless communication links 208 of FIG. 2. The wireless communication interfaces and wireless communication links can be implemented using any known types of wireless technologies including, but not limited to, Bluetooth, near infrared, WLAN, cellular, etc. Without limitation, the antennas can include, for example, a WLAN antenna that can be used to communicate information with a WLAN access point or interface over a WLAN communication link, a Bluetooth antenna that can be used to directly communicate information to/from another Bluetooth-enabled device, including those at the ground vehicle 210, over a Bluetooth communication link, and a near infrared network antenna that can be used to directly communicate information to another device, including those at the ground vehicle 210, over a near infrared communication link, a cellular network antenna that can be used to communicate information to/from a cellular base station over a cellular communication link.

The communication interfaces 388 can be used to communicate various signals over the air to the ground vehicle 210, external alert equipment (not illustrated) and apparatus associated with the operator of the ground vehicle 210. For instance, the communication interfaces 388 can send signals to alert equipment (such as a warning light 212, a display 213, a speaker 214 or tactile feedback devices 216, 218, 219) that are located in or on the ground vehicle 210 to cause the alert equipment to generate warning signal(s). In addition, the communication interfaces 388 can send signals to external alert equipment (e.g., a display, flashing light, or audio element) located external to the ground vehicle 210 and the aircraft 100 that cause the external alert equipment to generate the warning signal. Further, the communication interfaces 388 can also send signals to apparatus associated with the operator of the ground vehicle 210 that causes the apparatus to generate the warning signal.

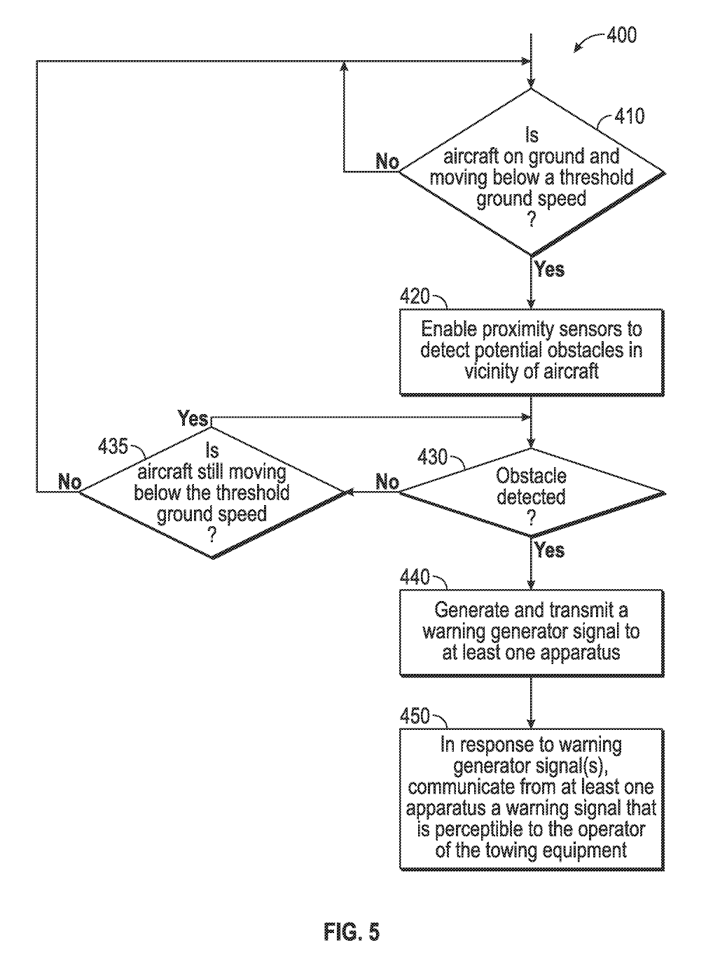

Further operational details of the collision warning and avoidance system 300 will now be described with reference to FIG. 5.

FIG. 5 is a flowchart of a method 400 for providing a warning to an operator of the ground vehicle when an obstacle is detected in proximity to the aircraft in accordance with some of the disclosed embodiments. The method 400 can be used, for example, when the ground vehicle is preparing to move or is moving the aircraft 100 and an obstacle 220 (or multiple obstacles) is/are detected in proximity to the aircraft 100 that could potentially collide with the aircraft. This can help prevent damage to an aircraft 100, for example, when the operator is moving the aircraft 100 and cannot see all extremities of the aircraft 100. The method 400 of FIG. 5 will be described below with reference to FIGS. 1-4 to explain how the method 400 could be applied in the context of one exemplary, non-limiting environment. It is noted that all the blocks/tasks/steps do not necessarily need to be performed in every implementation. In some implementations one or any combination of blocks/tasks/steps of FIG. 5 can be performed. For example, blocks 410, 420 and 435 are optional and not performed in all implementations of method 400. For instance, in some implementations, these steps are not needed, for example, when the system is manually enabled, or automatically enabled when the aircraft detects that it is being towed.

At 410, the processor 320 determines whether the aircraft 100 is on the ground and moving below a threshold ground speed. When the processor 320 determines that the aircraft 100 is either (1) not on the ground, or (2) is not moving or (3) is moving above a threshold ground speed, method 400 loops back to 410. This way, when the aircraft is in the air (i.e., not on the ground), or alternatively is on the ground and not moving, the system is effectively disabled. Similarly, when the aircraft is on the ground and moving above a certain ground speed, the system is effectively disabled.

By contrast, when the processor 320 determines that the aircraft 100 is both on the ground and moving below the threshold ground speed, the avoidance system 300 is enabled and the method 400 proceeds to 420. At 420, the processor 320 transmits a signal (or signals) to enable proximity sensors to detect potential obstacles in the vicinity of the aircraft 100, and can also transmit a signal (or signals) to enable the video imagers so that they acquire video images of various regions around the aircraft 100 that correspond to each of the video imagers. However, in some operational scenarios, the video imagers will already be enabled and is use for other purposes. This not only saves resources, but also prevents false system activations. As noted above, when a proximity sensor detects an obstacle, it transmits a detection signal to the processor 320 to indicate that an obstacle has been detected. In some implementations, the detection signal may optionally include information regarding the distance between the proximity sensor and the obstacle as well as the direction in which the obstacle has been detected.

At 430, the processor 320 determines whether any potential obstacles have been detected in proximity to the aircraft 100 by any of the proximity sensors. The processor 320 can make this determination using any of the techniques described above. In one embodiment, the processor 320 determines that an obstacle 220 is located in proximity to the aircraft 100 when the processor 320 receives and processes a detection signal from one of the proximity sensors 110. The detection signal includes information that indicates that a particular proximity sensor (that transmitted the detection signal) has detected the obstacle 220.

When the processor 320 determines that no detection signals have been received (and that no potential obstacles have been detected by the proximity sensors) at 430, the method 400 may then proceed to 435, where the processor 320 determines whether the aircraft 100 is still moving below the threshold ground speed. When the processor 320 determines (at 435) that the aircraft 100 is still moving at a ground speed that is less than the threshold ground speed, the method 400 loops back to 430 to continue monitoring for obstacles. When the processor 320 determines that the aircraft 100 is no longer moving (i.e., is stationary) at 435, the method 430 then loops back to 415 to restart the method 400.

By contrast, when the processor 320 determines at 430 that one or more detection signals have been received (thereby indicating that one or more potential obstacles have been detected and that a collision between the aircraft 100 and the detected obstacle is possible), the method 400 proceeds to 440.

In response to determining that an obstacle 220 is located in proximity to the aircraft 100, at 440, the processor 320 generates one or more warning generator signal(s) and communicates it/them to one or more apparatus. In some embodiments, before the processor generates the one or more warning generator signal(s), the processor 320 can also determine whether the aircraft is likely to collide with the obstacle 220 or is on a collision course with the obstacle 220.

The warning generator signal can vary depending on the implementation. For example, in accordance with some of the disclosed embodiments, the warning generator signal can be at least one of: (1) a control signal that is sent to warning equipment located in or on the aircraft 100 (e.g., external visual warning equipment 140 and/or external audio warning equipment 150 to cause the warning equipment to generate the warning signal (e.g., flashing lights and/or warning sounds), (2) a signal that is sent to alert equipment (such as a warning light 212, a display 213, a speaker 214 or tactile feedback devices 216, 218, 219) that are located in or on the ground vehicle 210 that causes the alert equipment to generate warning signal(s), (3) a command signal sent to external alert equipment (e.g., a light such as a strobe light) located external to the ground vehicle 210 and the aircraft 100 (e.g., a display, flashing light, or audio element) that causes the external alert equipment to generate the warning signal, and (4) an operator signal that is sent to an operator apparatus associated with the operator of the ground vehicle 210 and that causes the operator apparatus associated with the operator to generate the warning signal. Examples of apparatus (not illustrated) associated with the operator can include, for example, glasses worn by the operator having a display or light system integrated therein, and/or headphones worn by the operator that have a speaker system integrated therein. In the preceding list, the modifiers “control,” “command” and “operator” used in conjunction with the term “signal” are simply used to differentiate between the different types of signals based on their target or destination.

In response to the warning generator signal, at least one apparatus communicates, at 450, a warning signal that is perceptible to an operator of the ground vehicle 210 to warn the operator of the obstacle 220. The warning signal indicates to the operator of the ground vehicle 210 that an obstacle has been detected in the path of the aircraft, and that there is potential for a collision between the aircraft 100 and the obstacle 220.

As noted above, “perceptible to the operator” refers to the fact that the warning signal can be communicated to the operator via touch, sight, or sound (e.g., via any haptic, visual, or audible signal, or via any haptic, visual, or auditory modality). In general, the warning signal can include one or more of: an audible indication, a visual indication, and/or a haptic/tactile indication communicated to the operator of the ground vehicle 210 to warn the operator of the obstacle 220. Further, it will be noted that multiple types of each of these indications can be communicated to the operator depending on the implementation.

In addition, as mentioned above, the warning signal can be communicated to the operator via an apparatus located in or on the ground vehicle (or other towing equipment), via an apparatus located in or on the aircraft 100, via an apparatus located external to the ground vehicle and the aircraft 100 or via an operator apparatus. For example, depending on the implementation of the disclosed embodiments, the apparatus include one or more of: external visual warning equipment 140 and/or external audio warning equipment 150 located in or on the aircraft 100, alert equipment 212, 213, 214, 216, 218, 219 located in or on the ground vehicle 210, external alert equipment (not illustrated) located external to the ground vehicle 210 and the aircraft 100, and/or an operator apparatus (not illustrated) associated with the operator of the ground vehicle 210 that is configured to generate the warning signal.

### Non-limiting Example Implementations

As described above, the aircraft 100 includes external visual warning equipment 140 that can be mounted anywhere on the aircraft 100, such as a light mounted on a nose gear of the aircraft 100, a light mounted on a wingtip of the aircraft 100, a belly beacon light mounted on a belly of the aircraft 100. As such, in one embodiment, the processor 320 can generate control signal(s) to cause one or more of the external visual warning equipment 140 of the aircraft 100 to activate (e.g., turn on or flash in an on/off pattern) such that the visual indication is provided. Further, a specific light or lights may be activated depending on the area of the aircraft 100 nearest the obstacle 220.

The processor 320 can also generate signal(s) to cause one or more displays to display a visual indication or warning signal. The displays can be: located/mounted in or on the ground vehicle, located/mounted in or on the aircraft 100, located/mounted in or on ground equipment (e.g., in or on a building or other object that is on the ground), and/or located in or on a display of goggles warn by the operator. The visual indication can be in the form of a warning message that includes textual information, a flashing warning signal or any other type of warning signal that can be presented on a display that is viewable by the operator of the ground vehicle 210.

In addition, in some implementations, the visual indication can include an image presented on a display that is viewable by the operator of the ground vehicle 210. In some implementations, the image can be a video image provided from the video imager that is associated with the proximity sensor that detected the obstacle, and can show a particular region around the aircraft 100 that includes the obstacle 220 (e.g., a stream of video data from one or more imagers located on the aircraft 100). This allows a video image of the obstacle to be viewed by the operator of the ground vehicle.

In some implementations, the image can include one or more of: a representation of the aircraft 100 along with a representation of the obstacle 220 relative to the representation of the aircraft 100 to provide an indication of the position of the obstacle 220 relative to the aircraft 100; at least one indicator that identifies a particular region where the obstacle 220 is located with respect to the aircraft 100 and/or the ground vehicle 210; and/or an indication of a distance between the obstacle 220 and a particular portion of the aircraft 100, such as the particular proximity sensor that detected the obstacle 220, etc.

For example, in some implementations an aircraft diagram (e.g., a symbolic representation of the aircraft) along with a symbolic representation of the detected obstacle relative to the aircraft is displayed to provide the operator with an indication of the position of the detected obstacle relative to the aircraft. In addition, in some embodiments, the location of the video imager, that is providing the video image signal that is being displayed on the display, and/or the location of the proximity sensor that provided the detection signal can also be displayed along with a distance between the detected obstacle and that particular video imager and/or proximity sensor.

In addition, or alternatively, in some embodiments, a text indicator can be displayed, which identifies which video imager is providing the video image signal that is being displayed on the cockpit display, and/or which proximity sensor provided the signal that caused detection of the obstacle. In some embodiments, when the video image is displayed, an indicator (or multiple indicators when applicable) can be displayed to identify the particular video imager that is providing the video that is being displayed, and where the particular region (that is being displayed in the video image) is located with respect to the aircraft, and/or the relative position of the detected obstacle with respect to the aircraft.

These features help orient the operator as to which area of the aircraft corresponds to the video image being displayed. This provides the operator with a visual indication of where the obstacle is located with respect to the aircraft, and also provides the operator with a visual aid for determining what actions to take to avoid a collision.

The processor 320 can also generate signal(s) to cause one or more audio elements to generate an audio indication or warning signal. Examples of such audio indications can include, for example, at least one of: a horn, a bell, a buzzer, an alarm, a beeping sound, a siren sound, and a computerized voice that announces that an obstacle 220 is present near the aircraft 100 or within its projected path. In one embodiment, the audible indication is communicated to the operator via a dedicated speaker 214 that is mounted in or on the ground vehicle 210, and/or by speakers mounted in or on the aircraft 100, or via a headset or headphones (not illustrated) worn by the operator of the ground vehicle 210. The audio indication can be a computer voice signal generated by a computer voice system. The computer voice signal can be used to generate a computerized voice that communicates the general region where the obstacle 220 is present with respect to the aircraft 100 and/or its direction of movement. For example, when an obstacle is detected by proximity sensor 110-1, a computer voice can be generated that says “obstacle approaching near the left rear.” Similarly, when an obstacle is detected by proximity sensor 110-10, a computer voice can be generated that says “obstacle approaching near front left wingtip.” By contrast, when an obstacle is detected by proximity sensor 110-4, a computer voice can be generated that says “obstacle approaching near the rear left wingtip.”

In some embodiments, the ground vehicle 210 can be equipped with haptic feedback devices 216, 218, 219, in which case, the warning signal can be a haptic indication to warn the operator of the obstacle 220. For example, in response to the warning generator signal, a haptic warning signal can be communicated to the operator by causing a pulsating vibration at one or more parts 216, 218, 219 of the ground vehicle 210 (e.g., vibration of the accelerator and/or brake pedals, the steering wheel, seat or other portion of the ground vehicle) to warn the operator of the ground vehicle 210 of the obstacle 220.

The flowchart that is illustrated in FIG. 5 is exemplary, and is simplified for sake of clarity. In some implementations, additional blocks/tasks/steps can be implemented even though they are not illustrated in FIG. 5 for sake of clarity. These additional blocks/tasks/steps may occur before or after or in parallel and/or concurrently with any of the blocks/tasks/steps that are illustrated in FIG. 5. It is also noted that some of the blocks/tasks/steps illustrated in FIG. 5 may be optional and do not need to be included in every implementation of the disclosed embodiments. In some implementations, although not illustrated, the presence or absence of certain conditions may need to be confirmed prior to execution of a block/task/step or prior to completion of a block/task/step. In other words, a block/task/step may include one or more conditions that are to be satisfied before proceeding from that block/task/step to the next block/task/step. For example, in some cases, a timer, a counter or combination of both may execute and need to be satisfied before proceeding to the next block/task/step of the flowchart. As such, any block/task/step can be conditional on other blocks/tasks/steps that are not illustrated.

It is also noted that there is no order or temporal relationship implied by the flowchart of FIG. 5 unless the order or temporal relationship is expressly stated or implied from the context of the language that describes the various blocks/tasks/steps of the flowchart. The order of the blocks/tasks/steps can be varied unless expressly stated or otherwise implied from other portions of text.

In addition, in some implementations, FIG. 5 may include additional feedback or feedforward loops that are not illustrated for sake of clarity. The absence of a feedback or a feedforward loop between two points of the flowchart does not necessarily mean a feedback or feedforward loop is not present between the two points. Likewise, some feedback or feedforward loops may be optional in certain implementations. Although FIG. 5 is illustrated as including a single iteration this does not necessarily imply that the flowchart does not execute for a certain number of iterations or continuously or until one or more conditions occur.

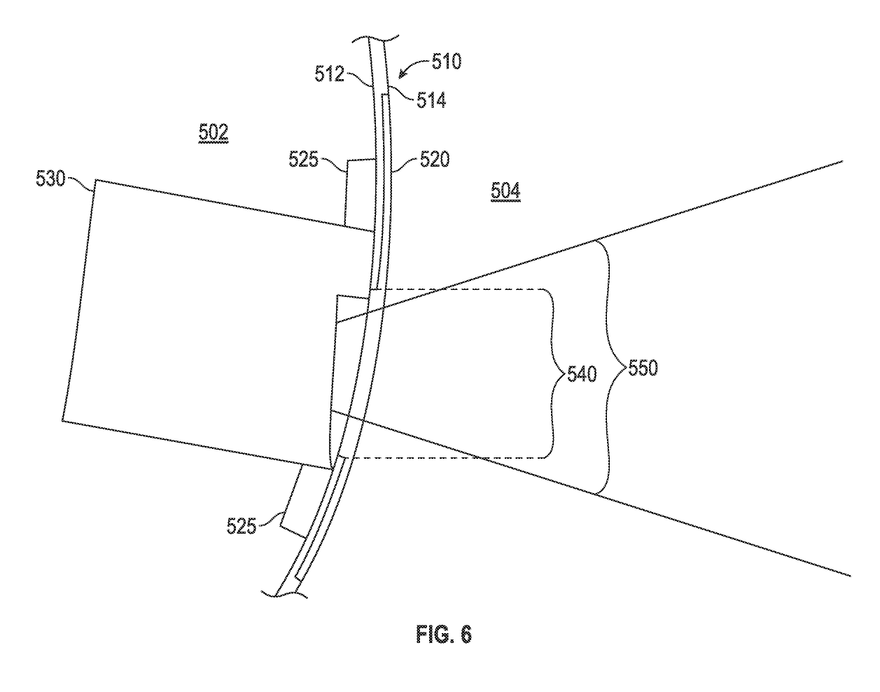

FIG. 6 is an illustration of a cross sectional view of a portion of an aircraft in accordance with an embodiment. FIG. 6 will be described with reference to FIGS. 1, 2 and 4.

The portion of the aircraft can be generally referred to as an aircraft structure 510. The aircraft structure 510 can be any portion of the aircraft body such as the fuselage 102, the vertical stabilizer 103, the horizontal stabilizers 104-1 and 104-2, the main wings 105-1 as described with reference to FIG. 1. In FIG. 6, reference numeral 502 designates the interior of the aircraft, and reference numeral 504 indicates that external environment outside the aircraft.

The aircraft structure 510 includes an internal surface 512 and an external surface 514. A window 520 is integrated or embedded within the aircraft structure 510 between the internal surface 512 and the external surface 514 (e.g., flush with the external surface 514). The internal surface 512 includes a mounting structure 525 attached thereto that can be used to mount a sensor 530 completely within the interior 502 of the aircraft. The sensor 530 can be, for example, any one of the proximity sensors 110, or video imagers 120 including any of those described above with reference to FIGS. 1, 2 and 4. As such, in one non-limiting implementation, the sensor 530 can be mounted at any of the locations described with reference to FIGS. 1 and 2.

The window 520 serves as a cover for the sensor 530. In one embodiment, the window 520 can be made of any clear material that allows transmission of at least one of ultraviolet (UV), infrared (IR), or other non-visible spectrum light.

The mounting structure 525 is positioned or arranged with respect to the window 520 such that the window 520 defines an aperture 540 within the aircraft structure 510 that allows the interior-mounted sensor 530 to capture information (e.g., motion information, video images, etc.) within a field of view (FOV) 550 as described above with reference to FIG. 1.

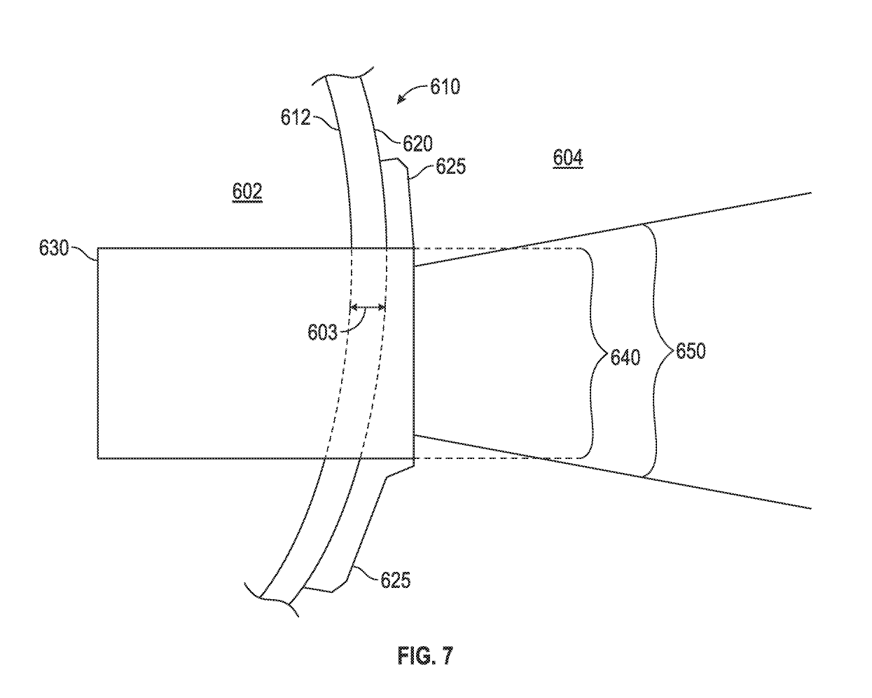

FIG. 7 is an illustration of a cross sectional view of a portion of an aircraft in accordance with another alternative embodiment. As in FIG. 6, the portion of the aircraft can be generally referred to as an aircraft structure 610, which can be any portion of the aircraft body as described above with reference to FIG. 6, and the sensor 630 can be any one of the sensors described above with reference to FIG. 6.

The aircraft structure 610 includes an internal surface 612 and an external surface 614; however, the embodiment illustrated in FIG. 7 differs from the embodiment illustrated in FIG. 6 in that the window 520 and mounting structure 525 of FIG. 6 can be eliminated.

In this embodiment, an opening 603 (illustrated by dashed lines in FIG. 7) is provided or formed within the aircraft structure 610 between the internal surface 612 and the external surface 614. The sensor 630 is mounted within the opening 603 in the aircraft structure 610 such that a portion of the sensor 630 is located inside the aircraft (e.g., within the interior 602 of the aircraft behind the internal surface 612 of the aircraft), another portion of the sensor 630 is located in the opening 603 between the internal surface 612 and the external surface 614 of the aircraft, and yet another portion of the sensor 630 protrudes from the aircraft structure 610 such that it is located outside the aircraft (e.g., outside the external surface 614 in the external environment 604 outside the aircraft). As such, the sensor 630 is mounted inside the interior of the aircraft, within a portion of the aircraft structure, and externally to the aircraft.

The external surface 614 of the aircraft structure 610 includes a fairing structure 625 attached thereto. The portion of the sensor 630 that is located outside the aircraft is covered by the fairing structure 625 to help prevent the sensor 630 from being exposed to the external environment 604 outside the aircraft. The fairing structure 625 includes an aperture 640 that allows the sensor 630 to capture information (e.g., motion information, video images, etc.) within a field of view (FOV) 650 as described above with reference to FIG. 1.

In some embodiments, it can be inconvenient or undesirable to modify the aircraft to integrate sensors in and/or on the aircraft. It would be desirable to provide sensors that can be temporarily mounted on the aircraft while it is on the ground, and then removed prior to flight.

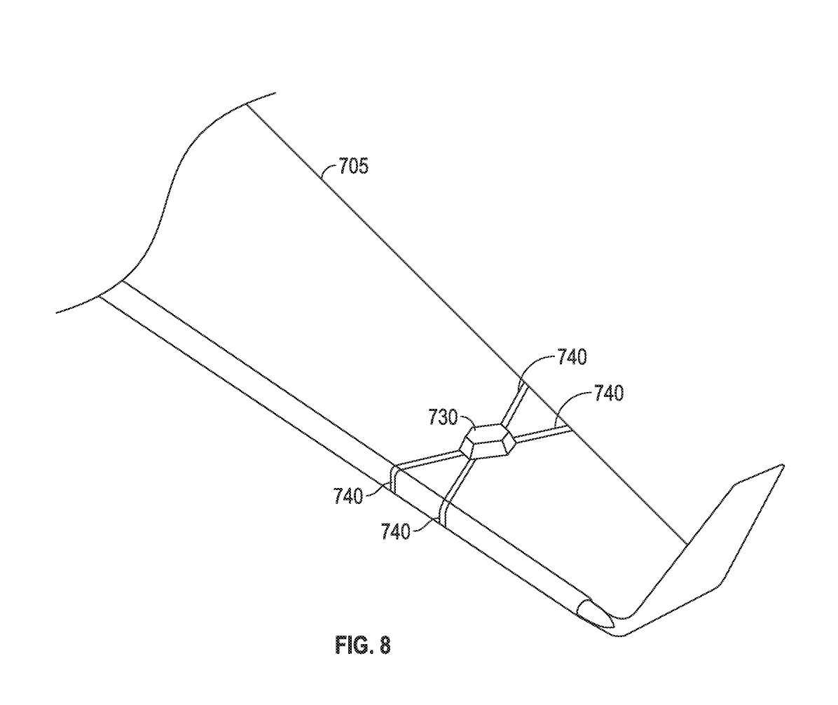

FIG. 8 is an illustration of a perspective view of a wing 705 of an aircraft and a detachable sensor apparatus 730, 740 in accordance with an embodiment. The implementation illustrated in FIG. 8 is non-limiting and the detachable sensor apparatus 730, 740 can be attached to other portions of the aircraft such as the fuselage 102, the vertical stabilizer 103, the horizontal stabilizers 104-1 and 104-2, etc. that are described with reference to FIG. 1.

The detachable sensor apparatus 730, 740 includes a housing 730 and an attachment mechanism 740. Although not illustrated, the housing 730 encloses one or more sensors (e.g., proximity sensors and/or video imagers including any of those described above with reference to FIGS. 1, 2 and 4), a processor, a wireless communication interface that includes a wireless receiver and a wireless transmitter, an antenna and a power source, such as a battery, that provides electrical power to the sensor(s), processor and the wireless communication interface. The wireless transmitter can communicate information (e.g., motion information, video images, etc.) acquired by the sensors over a wireless communication link to other devices as described above. The wireless communication interface can be implemented using any known types of wireless technologies including, but not limited to, Bluetooth, near infrared, WLAN, cellular, etc.

In this embodiment, the attachment mechanism 740 includes straps 740 that secure the housing 730 to the wing 705. The straps 740 can slide over the wing to hold the housing 730 in place while the aircraft is on the ground. Prior to flight, the detachable sensor apparatus 730, 740 can be removed from the wing 705. In an alternative embodiment, instead of using straps, the attachment mechanism could be a slip cover that is attached to the housing 730 and that slides over a portion of the aircraft (e.g., wing, winglet, a portion of the horizontal tail, etc.).

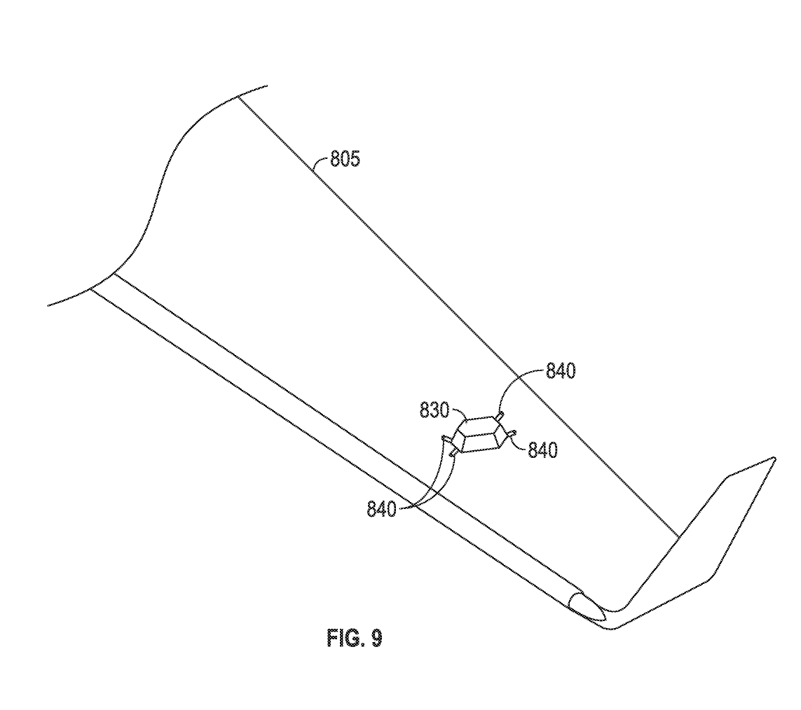

FIG. 9 is an illustration of a perspective view of a wing of an aircraft and a detachable sensor apparatus in accordance with another embodiment.

In this embodiment, the housing 805 is the same as described above with reference to FIG. 8, and the attachment mechanism 840 includes fasteners 840 that secure the housing 830 to the wing 805. In this implementation, the fasteners 840 can be implemented, for example, using retaining pins that are inserted in holes formed along the surface of the aircraft wing 805. Alternatively, the fasteners 840 can be implemented using a plug connection or a clip connection.

In another embodiment, that is not illustrated, the base of the sensor housing 730, 830 can include a quick release mechanism, such as a magnet or suction device, that can be used as the attachment mechanism to secure the housing 730, 830 to the wing 705, 805.

Those of skill in the art would further appreciate that the various illustrative logical blocks/tasks/steps, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. The word “exemplary” is used exclusively herein to mean “serving as an example, instance, or illustration.” Any embodiment described herein as “exemplary” is not necessarily to be construed as preferred or advantageous over other embodiments.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A collision avoidance system, comprising:
an aircraft comprising:
a plurality of proximity sensors mounted in or on an aircraft structure that is a portion of the aircraft at a plurality of extremity portions of the aircraft, the proximity sensors each being configured to detect presence of obstacles in proximity to the aircraft, and to transmit a detection signal when an obstacle is detected;
an onboard computer that is communicatively coupled to the plurality of proximity sensors, the onboard computer comprising: a processor that is configured to: determine that the obstacle is located in proximity to the aircraft in response to receiving the detection signal from a particular proximity sensor that indicates that the obstacle has been detected by the particular proximity sensor; and generate in response to determining that the obstacle is located in proximity to the aircraft, a warning generator signal;
a ground vehicle that is mechanically coupled to the aircraft so that the aircraft can be moved along a ground surface by the ground vehicle; and
an apparatus that is configured to communicate, in response to the warning generator signal, a warning signal that is perceptible to an operator of the ground vehicle to warn the operator of the obstacle.

2. A collision avoidance system according to claim 1, wherein the aircraft structure comprises an internal surface, an external surface, and a window that serves as a cover for a first proximity sensor of the plurality of proximity sensors, wherein the first proximity sensor is mounted in the aircraft structure between the internal surface and the external surface and flush with the external surface, and wherein the aircraft comprises a mounting structure that is attached to the internal surface and mounts the first proximity sensor completely within the interior of the aircraft.

3. A collision avoidance system according to claim 1, wherein the aircraft structure comprises an internal surface and an external surface, and further comprising: a fairing structure that is attached to the external surface, wherein a first proximity sensor of the plurality of proximity sensors is mounted in an opening formed in the aircraft structure between the internal surface and the external surface such that a first portion of the first proximity sensor is mounted inside the interior of the aircraft structure, a second portion of the first proximity sensor is mounted in the opening, and a third portion of the first proximity sensor is mounted in the fairing structure and protrudes outside of the aircraft structure.

4. A collision avoidance system according to claim 1, wherein a first proximity sensor of the plurality of proximity sensors is part of a detachable sensor apparatus that is detachably mounted on the outside of the aircraft structure of the aircraft, wherein the detachable sensor apparatus comprises:
a housing;
a processor;
a power source that provides electrical power to the first proximity sensor and the processor;
a wireless communication interface that includes a wireless receiver and a wireless transmitter that is configured to communicate information acquired by the first proximity sensor over a wireless communication link to another device, wherein the first proximity sensor, the power source, the processor and the wireless communication interface are mounted inside the housing;
an antenna; and
an attachment mechanism configured to temporarily mount the detachable sensor apparatus to the exterior of the aircraft.

5. A collision avoidance system according to claim 4, wherein the attachment mechanism comprises:
straps that are attached to the housing and that secure the detachable sensor apparatus to an exterior surface of the aircraft.

6. A collision avoidance system according to claim 4, wherein the attachment mechanism comprises:
fasteners that are attached to the housing and that secure the detachable sensor apparatus to an exterior surface of the aircraft.

7. A collision avoidance system according to claim 6, wherein the fasteners comprise:
retaining pins that are inserted in holes formed along a surface of the aircraft.

8. A collision avoidance system according to claim 4, wherein the attachment mechanism comprises:
a slip cover that is attached to the housing and slides over an exterior surface of the aircraft.

9. A collision avoidance system according to claim 4, wherein the attachment mechanism comprises:
a quick release mechanism that is attached to the housing and secures the housing to an exterior surface of the aircraft.

10. A collision avoidance system according to claim 1, wherein the apparatus is at least one of:
warning equipment located in or on the aircraft;
alert equipment located in or on the ground vehicle;
external alert equipment located external to the ground vehicle and the aircraft; and
an operator apparatus associated with the operator of the ground vehicle that is configured to generate the warning signal.

11. A collision avoidance system according to claim 10, wherein generating the warning generator signal, comprises:
in response to detecting the obstacle: generating, at the processor of the aircraft, at least one of:
a control signal that is sent to the warning equipment located in or on the aircraft to cause the warning equipment to generate the warning signal;
a signal that is sent to the alert equipment located in or on the ground vehicle that causes the alert equipment to generate the warning signal;
a command signal sent to the external alert equipment located external to the ground vehicle and the aircraft that causes an external system to generate the warning signal; and
an operator signal that is sent to the operator apparatus associated with the operator of the ground vehicle and that causes the operator apparatus associated with the operator to generate the warning signal.

12. A collision avoidance system according to claim 10, wherein the warning signal comprises at least one of:
an audible indication communicated to warn the operator of the ground vehicle of the obstacle;
a visual indication to warn the operator of the ground vehicle of the obstacle; and
a haptic indication at a part of the ground vehicle to warn the operator of the ground vehicle of the obstacle.

13. An aircraft, comprising:
a plurality of proximity sensors mounted in or on an aircraft structure that is a portion of the aircraft, where each of the proximity sensors is configured to detect presence of obstacles in proximity to the aircraft, and to transmit a detection signal when an obstacle is detected, wherein the detection signal indicates that the obstacle has been detected by a particular proximity sensor that transmitted the detection signal;
an onboard computer, communicatively coupled to the plurality of proximity sensors, the onboard computer comprising:
a processor that is configured to:
determine that the obstacle is located in proximity to the aircraft in response to receiving the detection signal from one of the plurality of proximity sensors;
generate in response to determining that the obstacle is located in proximity to the aircraft, a warning generator signal; and
communicate the warning generator signal to an apparatus, wherein the warning generator signal causes that apparatus to generate a warning signal that is perceptible to an operator of a ground vehicle to warn the operator of the obstacle.

14. An aircraft according to claim 13, wherein the aircraft structure comprises an internal surface, an external surface, and a window that serves as a cover for a first proximity sensor of the plurality of proximity sensors, wherein the first proximity sensor is mounted in the aircraft structure between the internal surface and the external surface and flush with the external surface, and wherein the aircraft comprises a mounting structure that is attached to the internal surface and mounts the first proximity sensor completely within the interior of the aircraft.

15. An aircraft according to claim 13, wherein the aircraft structure comprises an internal surface and an external surface, and further comprising: a fairing structure that is attached to the external surface, wherein a first proximity sensor of the plurality of proximity sensors is mounted in an opening formed in the aircraft structure between the internal surface and the external surface such that a first portion of the first proximity sensor is mounted inside the interior of the aircraft structure, a second portion of the first proximity sensor is mounted in the opening, and a third portion of the first proximity sensor is mounted in the fairing structure and protrudes outside of the aircraft structure.

16. An aircraft according to claim 13, wherein a first proximity sensor of the plurality of proximity sensors is part of a detachable sensor apparatus that is detachably mounted on the outside of the aircraft structure of the aircraft, wherein the detachable sensor apparatus comprises:
a housing;
a processor;
a power source that provides electrical power to the first proximity sensor and the processor;
a wireless communication interface that includes a wireless receiver and a wireless transmitter that is configured to communicate information acquired by the first proximity sensor over a wireless communication link to another device, wherein the first proximity sensor, the power source, the processor and the wireless communication interface are mounted inside the housing;
an antenna; and
an attachment mechanism configured to temporarily mount the detachable sensor apparatus to the exterior of the aircraft.

17. An aircraft according to claim 16, wherein the attachment mechanism comprises: straps or fasteners that are attached to the housing and that secure the detachable sensor apparatus to an exterior surface of the aircraft.

18. An aircraft according to claim 16, wherein the attachment mechanism comprises: a slip cover that is attached to the housing and slides over an exterior surface of the aircraft.

19. An aircraft according to claim 16, wherein the attachment mechanism comprises: a quick release mechanism that is attached to the housing and secures the housing to an exterior surface of the aircraft.

20. An aircraft according to claim 13, wherein the warning generator signal, comprises at least one of:
a control signal that is sent to warning equipment located in or on the aircraft to cause the warning equipment to generate the warning signal;
a signal that is sent to alert equipment located in or on the ground vehicle that causes the alert equipment to generate the warning signal;
a command signal sent to external alert equipment located external to the ground vehicle and the aircraft that causes an external system to generate the warning signal; and
an operator signal that is sent to an operator apparatus associated with the operator of the ground vehicle and that causes the operator apparatus associated with the operator to generate the warning signal, and
wherein the warning signal comprises at least one of:
an audible indication communicated to warn the operator of the ground vehicle of the obstacle;
a visual indication to warn the operator of the ground vehicle of the obstacle; and
a haptic indication at a part of the ground vehicle to warn the operator of the ground vehicle of the obstacle.
